(19) United States
(12) Patent Application Publication
(10) Pub. No.: US 2025/0024129 A1
(43) Pub. Date: Jan. 16, 2025

(54) CAMERA MODULE AND METHOD OF MANUFACTURING CAMERA MODULE

(71) Applicant: Sharp Sensing Technology Corporation, Tenri City (JP)

(72) Inventors: TAKAMIZU SASAKI, Tenri City (JP); KAZUHIRO MORIMOTO, Tenri City (JP); KEIICHIRO ICHIBA, Tenri City (JP); KEIICHI SAWAI, Tenri City (JP); TAKAAKI FUNAKOSHI, Tenri City (JP)

(21) Appl. No.: 18/768,083

(22) Filed: Jul. 10, 2024

(30) Foreign Application Priority Data
Jul. 13, 2023 (JP) 2023-115379

(51) Int. Cl. H04N 23/55; H04N 23/54

(52) U.S. Cl. CPC H04N 23/55; H04N 23/54

(57) ABSTRACT

A camera module includes a substrate; an image sensor including a light-receiving unit and mounted to a top face of the substrate; a lens holder mounted to the top face of the substrate so as to cover the image sensor; and a lens held by the lens holder, wherein an inner circumferential surface of the lens holder and an outer circumferential surface of the image sensor have such a positional relationship that an offset in an in-plane direction of the substrate between a center line of the image sensor and an optical axis of the lens is smaller than or equal to a tolerable error.

### CROSS-REFERENCE TO RELATED APPLICATION

The present application claims priority from Japanese Application JP 2023-115379, the content of which is hereby incorporated by reference into this application.

### BACKGROUND OF THE INVENTION

### Field of the Invention

The present invention relates to camera modules and methods of manufacturing camera modules.

### Description of the Related Art

Image capturing modules are known that include, in the form of a module, an image sensor and a lens for focusing incoming light on the image sensor. As an example, Japanese Unexamined Patent Application Publication No. 2012-74781 discloses an image capturing module in which a holder member containing therein a converging lens for focusing subject light on a sensor chip is attached onto a substrate in such a manner as to cover the sensor chip.

In the image capturing module of Japanese Unexamined Patent Application Publication No. 2012-74781, a projection of the holder member is fitted into a depression in a peripheral region other than the image capturing region of the sensor chip. This particular structure precisely specifies the heightwise distance between the image capturing region of the sensor chip and the converging lens. The structure also precisely aligns the center position of the image capturing region of the sensor chip and the optical axis of the converging lens in directions parallel to the substrate surface.

However, the image capturing module of Japanese Unexamined Patent Application Publication No. 2012-74781 has an undesirable need to provide a depression on the sensor chip as additional fabrication of the sensor chip.

The present invention, in an aspect thereof, has an object to provide a camera module that enables positioning of the lens holder in an in-plane direction of the substrate without additional fabrication of the image sensor and also to provide a method of manufacturing such a camera module.

To achieve this object, the present invention, in one aspect thereof, is directed to a camera module including: a substrate; an image sensor including a light-receiving unit and mounted to a top face of the substrate; a lens holder mounted to the top face of the substrate so as to cover the image sensor; and a lens held by the lens holder. An inner circumferential surface of the lens holder and an outer circumferential surface of the image sensor have such a positional relationship that an offset in an in-plane direction of the substrate between a center line of the image sensor and an optical axis of the lens is smaller than or equal to a tolerable error.

The present invention, in one aspect thereof, is directed to a method of manufacturing a camera module, the method including: a lens mounting step of mounting a lens in a lens holder; an image sensor mounting step of mounting an image sensor to a top face of a substrate; a coating step of applying an adhesive to the top face of the substrate outside the image sensor, the adhesive being configured to attach the lens holder; and a fixing step of fixing the lens holder to the top face of the substrate via the adhesive. An inner circumferential surface of the lens holder and an outer circumferential surface of the image sensor have such a positional relationship that an offset in an in-plane direction of the substrate between a center line of the image sensor and an optical axis of the lens is smaller than or equal to a tolerable error.

The present invention, in an aspect thereof, enables positioning of the lens holder in an in-plane direction of the substrate without additional fabrication of the image sensor.

### BRIEF DESCRIPTION OF THE DRAWINGS

FIG. 1 is a cross-sectional view of a structure of a camera module in accordance with Embodiment 1 of the present invention.

FIG. 2 is a top view of the structure of the camera module in accordance with Embodiment 1.

FIG. 3 is a cross-sectional view after a lens mounting step is completed in accordance with Embodiment 1.

FIG. 4 is a cross-sectional view of an image sensor mounting step in accordance with Embodiment 1.

FIG. 5 is a cross-sectional view after a coating step is completed in accordance with Embodiment 1.

FIG. 6 is a cross-sectional view after a fixing step is completed in accordance with Embodiment 1.

FIG. 7 is a cross-sectional view of a structure of a camera module in accordance with Embodiment 2.

FIG. 8 is a top view of the structure of the camera module in accordance with Embodiment 2.

### DETAILED DESCRIPTION OF THE INVENTION

### Embodiment 1

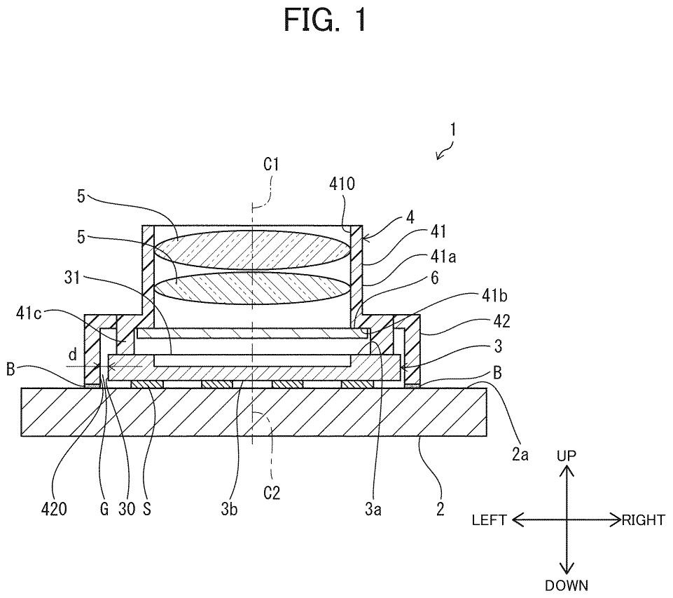

The following will describe a camera module 1 in accordance with Embodiment 1 of the present invention with reference to FIGS. 1 to 6.

### Structure of Camera Module

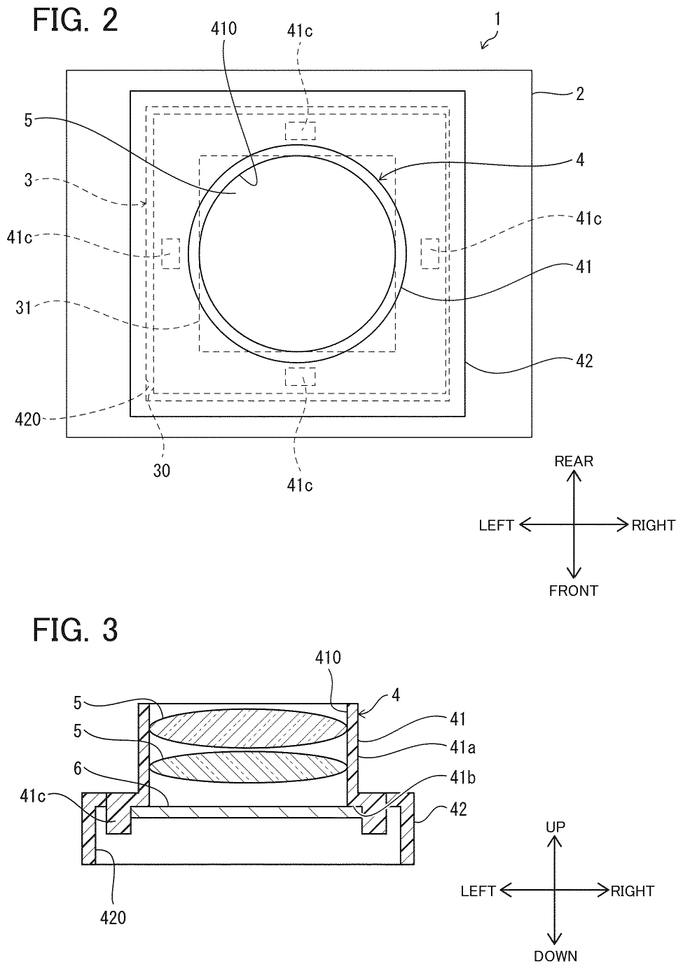

FIG. 1 is a cross-sectional view of a structure of the camera module 1 in accordance with Embodiment 1. FIG. 2 is a top view of the structure of the camera module 1 in accordance with Embodiment 1. Referring to FIGS. 1 and 2, the camera module 1 includes a substrate 2, a sensor chip 3, a lens holder 4, lenses 5, and an optical filter 6. The optical filter 6 is omitted in FIG. 2.

The camera module 1 is mounted, for example, to an electronic apparatus such as a mobile terminal. The substrate 2 is a rectangular platelike member and may be, for example, a flexible substrate or a rigid substrate. Throughout the following description, the up-down, left-right, and front-back directions for the camera module 1 are defined as indicated by arrows in FIGS. 1 and 2 for convenience of description.

The sensor chip 3 is mounted onto a top face 2a of the substrate 2. The substrate 2 outputs an electric signal containing the image data acquired from the sensor chip 3 via a terminal connected to the substrate 2 (not shown) to a control unit (not shown) in the mobile terminal to which the camera module 1 is mounted.

The sensor chip 3 is an image sensor. The sensor chip 3 may be, for example, an integrated circuit including either a CCD (charge coupled device) or a CMOS (complementary metal oxide semiconductor). The sensor chip 3 captures an image by converting, to electric signals, optical signals obtained by receiving the light focused by the lenses 5.

The sensor chip 3 has a bottom face 3b electrically connected to the substrate 2 by a plurality of solder balls S. Note that the sensor chip 3 may alternatively be electrically connected to the substrate 2 by, for example, wires.

The sensor chip 3 has a top face 3a of provided thereon with a rectangular light-receiving unit 31. The light-receiving unit 31 is a region formed in the center of the top face 3a of of the sensor chip 3 to form an image thereon from the light coming from the lenses 5. The light-receiving unit 31 includes a matrix of light-receiving elements. The light-receiving elements electrically convert the subject's image formed on the light-receiving unit 31.

The lens holder 4 is mounted on the top face 2a of The substrate 2 so as to cover the exterior of the sensor chip 3. The lens holder 4 is a hollow member made of, for example, a resin such as polycarbonate or liquid crystal polymer (LCP). The lens holder 4 is fixed to the top face 2a of the substrate 2 using adhesive B. Note that the lens holder 4 is not necessarily made of a resin, but may be made of, for example, a metal.

The adhesive B is, for example, ultraviolet-light thermosetting adhesive. Ultraviolet-light thermosetting adhesives are photocuring and thermosetting resins that preliminarily cure under ultraviolet light and completely cure when heated. Note that the adhesive B is not necessarily an ultraviolet-light thermosetting adhesive, but may be a thermosetting adhesive. In addition, the substrate 2 and the lens holder 4 are not necessarily fixed using the adhesive B, but may alternatively be fixed using, for example, tape or screws.

Referring to FIG. 1, the lens holder 4 is an integration of a first holder 41 and a second holder 42 that is connected to a lower part of the first holder 41. Note that the lens holder 4 may be constructed from a single member.

The first holder 41 has: a cylindrical cylinder portion 41a; a step portion 41b connected to a lower part of the cylinder portion 41a; and contact portions 41c that protrude downward from the step portion 41b and in contact with the top face 3a of the sensor chip 3. The second holder 42 is shaped like a rectangular box and provided so as to cover the sensor chip 3.

The cylinder portion 41a of the lens holder 4 has an inner circumferential surface 410 where the two lenses 5 are held in place. The lenses 5 guide the light incident to the camera module 1 to the light-receiving unit 31 in the sensor chip 3. Note that the number of the lenses 5 is not necessarily two, but may be changed where appropriate.

The optical filter 6 is fixed to the step portion 41b of the lens holder 4. The optical filter 6 blocks, for example, infrared light (IR: infrared radiation) in the light focused by the lenses 5. Note that the optical filter 6 may be replaced by cover glass. In addition, the optical filter 6 is not essential.

Four contact portions 41c are provided protruding along the periphery of the bottom face of the first holder 41 at circumferential intervals. Each contact portion 41c has a bottom face positioned, closer to the periphery than the light-receiving unit 31, on the top face 3a of of the sensor chip 3 and in contact with the sensor chip 3. The heightwise positioning, in other words, the positioning in the up-down direction in FIG. 1, of the lenses 5 and the sensor chip 3 is hence done.

The height of the contact portions 41c, in other words, the length of the contact portions 41c in the up-down direction in FIG. 1, is specified so as to provide an appropriate distance between the lenses 5 and the sensor chip 3. Note that the number of the contact portions 41c is not necessarily four, but may be, for example, three. In addition, the contact portions 41c may be provided protruding along the entire periphery of the first holder 41.

The second holder 42 has a bottom face fixed to the top face 2a of the substrate 2 using the adhesive B. Specifically, the lens holder 4, holding the lenses 5, is fixed to the top face 2a of the substrate 2 so as to cover, the sensor chip 3 mounted to the substrate 2.

Referring to FIG. 1, there is formed a gap G between an inner circumferential surface 420 of the second holder 42 in the lens holder 4 and an outer circumferential surface 30 of the sensor chip 3. The size of the gap G, in other words, the distance d between the inner circumferential surface 420 of the second holder 42 and the outer circumferential surface 30 of the sensor chip 3, changes when the lens holder 4 is displaced in an in-plane direction of the substrate 2 in fixing the lens holder 4 to the substrate 2. A change in the distance d indicates an offset between the optical axis C1 of the lenses 5 and the center line C2 of the sensor chip 3.

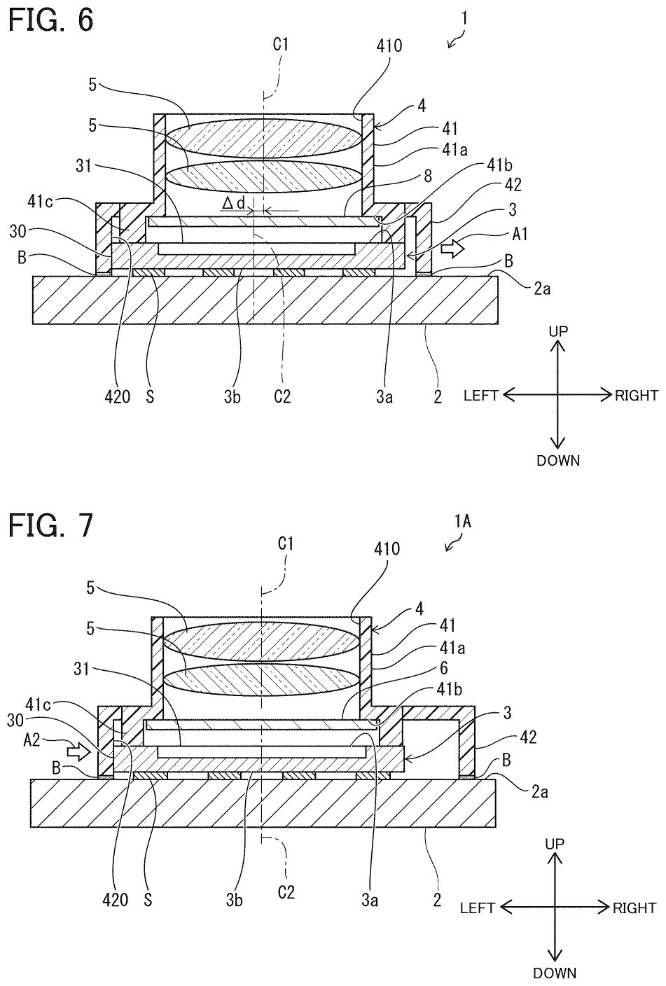

In the camera module 1, if the position of the inner circumferential surface 420 of the second holder 42 in the lens holder 4 is displaced in either the left-right direction or the front-back direction in FIG. 2, the inner circumferential surface 420 of the second holder 42 and the outer circumferential surface 30 of the sensor chip 3 come into contact with each other as shown in FIG. 6 (detailed later). When this is the case, the offset Ad (see FIG. 6) between the optical axis Cl of the lenses 5 and the center line C2 of the sensor chip 3 is smaller than or equal to a tolerable error. This offset Δd does not exceed the tolerable error in the camera module 1 because the displacement of the lens holder 4 is a maximum when the inner circumferential surface 420 of the second holder 42 and the outer circumferential surface 30 of the sensor chip 3 are in contact with each other.

As described here, the relative positions of the inner circumferential surface 420 of the second holder 42 in the lens holder 4 and the outer circumferential surface 30 of the sensor chip 3 are such that the offset Δd between the optical axis Cl of the lenses 5 and the center line C2 of the sensor chip 3 is smaller than or equal to a tolerable error.

In the current context, the “tolerable error” is approximately an offset Ad that does not adversely affect the optical properties, such as shading property, of the camera module 1. The tolerable error is set to, for example, approximately 50 μm.

### Method of Manufacturing Camera Module

A description is given next of an exemplary method of manufacturing the camera module 1 with reference to FIGS. 3 to 6. The method of manufacturing the camera module 1 involves a lens mounting step S1, an image sensor mounting step S2, a coating step S3, and a fixing step S4, which are performed in the stated order. Note that the lens mounting step S1 and the image sensor mounting step S2 are not necessarily performed in this order and may be performed in the reverse order. In addition, the lens mounting step S1 and the image sensor mounting step S2 may be parallelly performed, and, for example, the lens mounting step S1 and the image sensor mounting step S2 may be performed in respective, separate locations.

The lens mounting step S1 is described first with reference to FIG. 3. FIG. 3 is a cross-sectional view after the lens mounting step S1 is completed. Referring to FIG. 3, in the lens mounting step S1, the two lenses 5 are mounted by fixing the lenses 5 inside the cylinder portion 41a of of the first holder 41 in the lens holder 4. In addition, the optical filter 6 is fixed to the step portion 41b of the first holder 41.

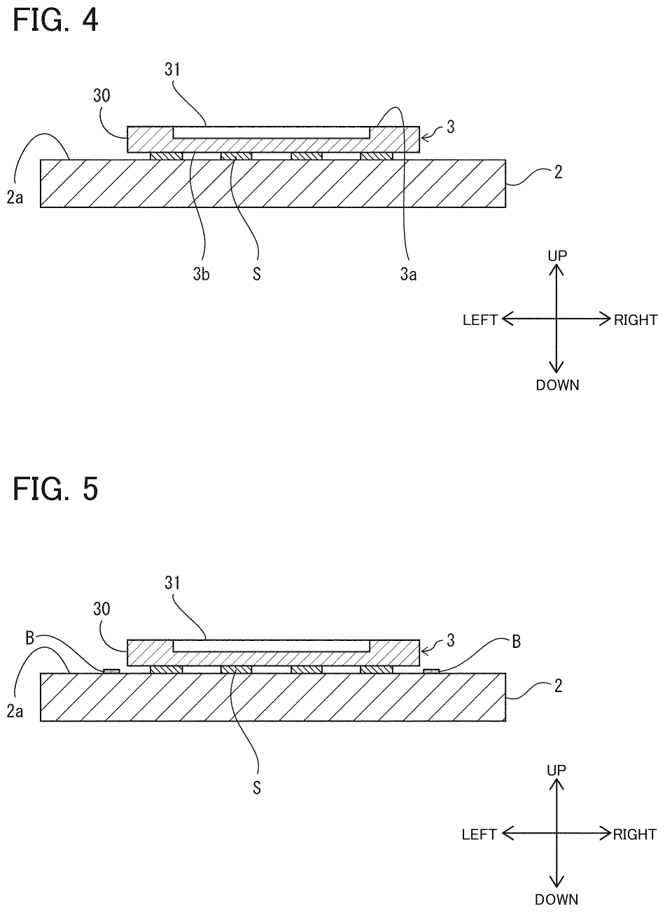

The image sensor mounting step S2 is described next with reference to FIG. 4. FIG. 4 is a cross-sectional view of the image sensor mounting step S2. Referring to FIG. 4, in the image sensor mounting step S2, the sensor chip 3 is fixed in a prescribed position on the top face 2a of the substrate 2 using the plurality of solder balls S. The sensor chip 3 is electrically connected to an electrode (not shown) disposed on the top face 2a of the substrate 2 via the plurality of solder balls S.

The coating step S3 is described next with reference to FIG. 5. FIG. 5 is a cross-sectional view after the coating step S3 is completed. Referring to FIG. 5, in the coating step S3, the adhesive B for attaching the lens holder 4 is applied to the top face 2a of the substrate 2 outside the sensor chip 3.

Note that taking into consideration that the lens holder 4 could be displaced in an in-plane direction of the substrate 2, in other words, in either the left-right direction or the front-back direction in FIG. 2, the adhesive B is preferably applied to a region larger than the region where the bottom face of the second holder 42 in the lens holder 4 comes into contact with the top face 2a of the substrate 2.

The fixing step S4 is described next with reference to FIG. 6. FIG. 6 is a cross-sectional view after the fixing step S4 is completed. Referring to FIG. 6, in the fixing step S4, the lens holder 4 is fixed to the top face 2a of the substrate 2 via the adhesive B.

In the fixing step S4, first, the lens holder 4 is placed in a target mounting position on the top face 2a of the substrate 2 so that the optical axis C1 of the lenses 5 held in place by the lens holder 4 is aligned with the center line C2 of the sensor chip 3 mounted to the substrate 2.

In the current context, the location of the center line C2 of the sensor chip 3 is determined on the basis of the center of the light-receiving unit 31 calculated through the image recognition of the light-receiving unit 31 in the sensor chip 3 using an image scanning device such as a camera (not shown). In addition, the location of the optical axis C1 of the lenses 5 is similarly determined on the basis of the center position of the cylinder portion 41a calculated through the image recognition of the lens holder 4 using an image scanning device.

Note that the center line C2 of the sensor chip 3 and the optical axis Cl of the lenses 5 may be aligned by providing a mark indicating the center line C2 of the sensor chip 3 on the top face 3a of the sensor chip 3 and placing the lens holder 4 using this mark.

Next, the lens holder 4 is preliminarily fixed in a prescribed position on the substrate 2 by preliminarily curing the adhesive B under ultraviolet light projected onto the adhesive B applied between the substrate 2 and the lens holder 4. Then, the lens holder 4 is completely fixed to the substrate 2 by placing the substrate 2 and the lens holder 4, which are preliminarily fixed, for example, in an oven (not shown) and then completely curing the adhesive B in heat.

Here, the lens holder 4 could be displaced from the target mounting position on the substrate 2 as shown in FIG. 6 because, for example, an external force may be exerted when the substrate 2 and the lens holder 4, which are preliminarily fixed, are moved into the oven or the adhesive B may contract before being completely cured.

The example shown in FIG. 6 shows the lens holder 4 having moved to the right relative to the substrate 2 as indicated by white arrow A1. In this case, the camera module 1 is configured to restrain the rightward movement of the lens holder 4 by the left-side inner circumferential surface 420 of the second holder 42 in the lens holder 4 moving into contact with the left-side outer circumferential surface 30 of the sensor chip 3. The camera module 1 is hence structured so that the offset Ad between the optical axis C1 of the lenses 5 and the center line C2 of the sensor chip 3 remains smaller than or equal to a tolerable error.

### Effects of Embodiment 1

As described above, in the camera module 1 in accordance with Embodiment 1 is configured, as shown in FIG. 1, the relative positions of the inner circumferential surface 420 of the second holder 42 in the lens holder 4 and the outer circumferential surface 30 of the sensor chip 3 are such that the offset Δd (see FIG. 6) between the optical axis C1 of the lenses 5 and the center line C2 of the sensor chip 3 remains smaller than or equal to a tolerable error.

In other words, even if the lens holder 4 is displaced in an in-plane direction of the substrate 2, in other words, in either the left-right direction or the front-back direction in FIG. 2, as shown in FIG. 6, the inner circumferential surface 420 of the second holder 42 and the outer circumferential surface 30 of the sensor chip 3 come into contact with each other, which restrains the displacement of the lens holder 4 in the in-plane direction of the substrate 2.

Hence, the offset Δd in an in-plane direction of the substrate 2 between the optical axis C1 of the lenses 5 and the center line C2 of the sensor chip 3 can be rendered to remain smaller than or equal to the tolerable error. Therefore, the positioning of the lens holder 4 in the in-plane direction of the substrate 2 can be highly precisely performed without additional fabrication of the sensor chip 3.

In addition, the gap G is provided between the inner circumferential surface 420 of the second holder 42 and the outer circumferential surface 30 of the sensor chip 3. Therefore, even when the size of the lens holder 4 and the size of the sensor chip 3 slightly vary during the manufacture, the lens holder 4 can be suitably disposed on the top face 2a of of the substrate 2 without disrupting the sensor chip 3.

In addition, in the camera module 1, since the contact portions 41c of the lens holder 4 are in contact with the top face 3a of the sensor chip 3, the heightwise positioning, in other words, the positioning in the up-down direction, of the sensor chip 3 and the lenses 5 held in place by the lens holder 4 can be highly precisely performed.

In addition, the lens holder 4 and the substrate 2 are fixed by the ultraviolet-light thermosetting adhesive B. Therefore, the fixing strength of the lens holder 4 and the substrate 2 can be improved by projecting ultraviolet light onto the lens holder 4 and the substrate 2 to preliminarily cure the adhesive B and then heating the lens holder 4 and the substrate 2 to completely cure the adhesive B.

### Embodiment 2

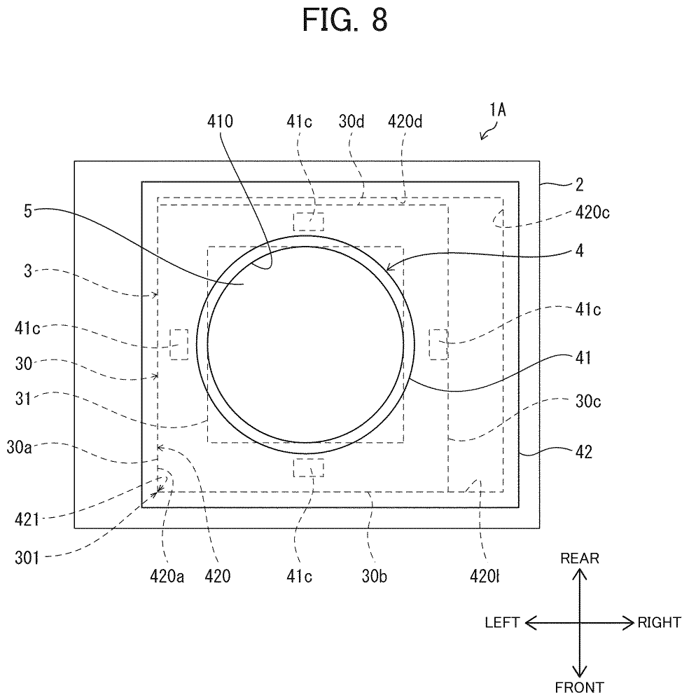

A description is given next of a camera module 1A in accordance with Embodiment 2 with reference to FIGS. 7 and 8. Note that for convenience of description, members of the present embodiment that have the same function as members of Embodiment 1 above are indicated by the same reference numerals, and description thereof is omitted.

FIG. 7 is a cross-sectional view of a structure of the camera module 1A in accordance with Embodiment 2. FIG. 8 is a top view of the structure of the camera module 1A in accordance with Embodiment 2. Throughout the following description, the up-down, left-right, and front-back directions for the camera module 1A are defined as indicated by arrows in FIGS. 7 and 8 for convenience of description.

### Structure of Camera Module

Referring to FIG. 7, the camera module 1A in accordance with Embodiment 2 differs from the camera module 1 in accordance with Embodiment 1 in that in the former, the optical axis C1 of the lenses 5 and the center line C2 of the sensor chip 3 are aligned when a part of the inner circumferential surface 420 of the second holder 42 in the lens holder 4 and a part of the outer circumferential surface 30 of the sensor chip 3 move into contact with each other.

In other words, referring to FIG. 8, in the camera module 1A, the optical axis C1 of the lenses 5 and the center line C2 of the sensor chip 3 are aligned when a left-side inner circumferential surface 420a of the second holder 42 is in contact with a left-side outer circumferential surface 30a of the sensor chip 3, and a front-side inner circumferential surface 420b of the second holder 42 is in contact with a front-side outer circumferential surface 30b of the sensor chip 3. By designing the size of the lens holder 4 and the size of the sensor chip 3 as described here, the offset Ad (see FIG. 6) between the optical axis C1 of the lenses 5 and the center line C2 of the sensor chip 3 can be rendered to remain smaller than or equal to a tolerable error.

Note that a right-side inner circumferential surface 420c of the lens holder 4 is not in contact with a right-side outer circumferential surface 30c of the sensor chip 3. In addition, a rear-side inner circumferential surface 420d of the lens holder 4 is not in contact with a rear-side outer circumferential surface 30d of the sensor chip 3.

### Method of Manufacturing Camera Module

A description is given next of a method of manufacturing the camera module 1A with reference to FIGS. 7 and 8. The method of manufacturing the camera module 1A involves the lens mounting step S1, the image sensor mounting step S2, the coating step S3, and the fixing step S4, which are performed in the stated order.

In the method of manufacturing the camera module 1A in accordance with Embodiment 2, the lens mounting step S1, the image sensor mounting step S2, and the coating step S3 are performed in the same manner as in the method of manufacturing the camera module 1 in accordance with Embodiment 1, and the fixing step S4 differs from Embodiment 1.

The following will describe the fixing step S4 in accordance with Embodiment 2 in detail. In the fixing step S4, the left-hand inner circumferential surface 420a of the second holder 42 is moved into contact with the left-hand outer circumferential surface 30a of the sensor chip 3 by pressing the lens holder 4 along the top face 2a of the substrate 2 as indicated by white arrow A2 in FIG. 7. Furthermore, the front-side inner circumferential surface 420b of the second holder 42 is moved into contact with the front-side outer circumferential surface 30b of the sensor chip 3.

In other words, a left-front corner 421 of the second holder 42 in the lens holder 4 is brought into contact with a left-front corner 301 of the sensor chip 3. In this manner, a positioning step S41 is performed of aligning the optical axis Cl of the lenses 5 and the center line C2 of the sensor chip 3.

Note that in bringing the left-front corner 421 of the second holder 42 in the lens holder 4 into contact with the left-front corner 301 of the sensor chip 3, the contact of the inner circumferential surface 420a of of the second holder 42 with the outer circumferential surface 30a of the sensor chip 3 and the contact of the inner circumferential surface 420b of the second holder 42 with the outer circumferential surface 30b of the sensor chip 3 may be detected using, for example, a weight sensor. When this is the case, the sensor chip 3 can be prevented from, for example, being damaged, by stopping the pressing of the lens holder 4 upon detecting the inner circumferential surfaces 420a, 420b of the second holder 42 having come into contact with the outer circumferential surfaces 30a, 30b of the sensor chip 3 using, for example, a weight sensor.

Next, the lens holder 4 is preliminarily fixed to the substrate 2 by preliminarily curing the adhesive B under ultraviolet light projected onto the adhesive B applied between the substrate 2 and the lens holder 4. Then, the lens holder 4 is completely fixed to the substrate 2 by placing the substrate 2 and the lens holder 4, which are preliminarily fixed, in, for example, an oven and then completely curing the adhesive B in heat. The fixing step S4 including the positioning step S41 is hence completed.

### Effects of Embodiment 2

In the camera module 1A described above, a part of the inner circumferential surface 420 of the second holder 42 in the lens holder 4 is brought into contact with a part of the outer circumferential surface of the sensor chip 3. In other words, the left-hand inner circumferential surface 420a of the second holder 42 is brought into contact with the left-hand outer circumferential surface 30a of of the sensor chip 3, and the front-side inner circumferential surface 420b of the second holder 42 is brought into contact with the front-side outer circumferential surface 30b of the sensor chip 3. The positioning of the optical axis C1 of the lenses 5 and the center line C2 of the sensor chip 3 can be hence performed.

Therefore, the positioning of the substrate 2 in an in-plane direction can be performed with a simple structure without additional fabrication of the sensor chip 3. The scanning of the external shape of the sensor chip 3 using a camera or a like image scanning device hence eliminates the need to determine the location of the center line C2 of the sensor chip 3.

Note that in the camera module 1A in accordance with Embodiment 2 described above, the left-hand inner circumferential surface 420a of the second holder 42 in the lens holder 4 and the left-hand outer circumferential surface 30a of the sensor chip 3 have been described as being in contact with the front-side inner circumferential surface 420b of the second holder 42 and the front-side outer circumferential surface 30b of the sensor chip 3, which is merely illustrative.

For instance, the camera module 1A may be designed so that the optical axis C1 of the lenses 5 is aligned with the center line C2 of the sensor chip 3 when the right-hand inner circumferential surface 420c of the second holder 42 is in contact with the right-hand outer circumferential surface 30c of the sensor chip 3, and the rear-side inner circumferential surface 420d of the second holder 42 is in contact with the rear-side outer circumferential surface 30d of the sensor chip 3.

### General Description

The present invention, in aspect 1 thereof, is directed to a camera module including: a substrate; an image sensor including a light-receiving unit and mounted to a top face of the substrate; a lens holder mounted to the top face of the substrate so as to cover an exterior of the image sensor; and a lens held by the lens holder. An inner circumferential surface of the lens holder and an outer circumferential surface of the image sensor have such a positional relationship that an offset in an in-plane direction of the substrate between a center line of the image sensor and an optical axis of the lens is smaller than or equal to a tolerable error.

In aspect 2 of the present invention, the camera module may be configured such that a part of the inner circumferential surface of the lens holder is in contact with a part of the outer circumferential surface of the image sensor.

In aspect 3 of the present invention, the camera module of aspect 1 may be configured such that the tolerable error is approximately 50 μm.

In aspect 4 of the present invention, the camera module of any of aspects 1 to 3 may be configured such that the lens holder has a contact portion that comes into contact with the image sensor.

In aspect 5 of the present invention, the camera module of any of aspects 1 to 4 may be configured such that the lens holder and the substrate are fixed by an adhesive.

The present invention, in aspect 6 thereof, is directed to a method of manufacturing a camera module, the method including: a lens mounting step of mounting a lens in a lens holder; an image sensor mounting step of mounting an image sensor to a top face of a substrate; a coating step of applying an adhesive to the top face of the substrate outside the image sensor, the adhesive being configured to attach the lens holder; and a fixing step of fixing the lens holder to the top face of the substrate via the adhesive. An inner circumferential surface of the lens holder and an outer circumferential surface of the image sensor have such a positional relationship that an offset in an in-plane direction of the substrate between a center line of the image sensor and an optical axis of the lens is smaller than or equal to a tolerable error.

In aspect 7 of the present invention, the method of aspect 6 may be configured such that the fixing step includes a positioning step of aligning the optical axis of the lens and the center line of the image sensor by moving a part of the inner circumferential surface of the lens holder into contact with a part of the outer circumferential surface of the image sensor mounted to the top face of the substrate.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A camera module comprising:
a substrate;
an image sensor including a light-receiving unit and mounted to a top face of the substrate;
a lens holder mounted to the top face of the substrate so as to cover the image sensor; and
a lens held by the lens holder, wherein
an inner circumferential surface of the lens holder and an outer circumferential surface of the image sensor have such a positional relationship that an offset in an in-plane direction of the substrate between a center line of the image sensor and an optical axis of the lens is smaller than or equal to a tolerable error.

2. The camera module according to claim 1, wherein a part of the inner circumferential surface of the lens holder is in contact with a part of the outer circumferential surface of the image sensor.

3. The camera module according to claim 1, wherein the tolerable error is approximately 50 μm.

4. The camera module according to claim 1, wherein the lens holder has a contact portion that comes into contact with the image sensor.

5. The camera module according to claim 1, wherein the lens holder and the substrate are fixed by an adhesive.

6. A method of manufacturing a camera module, the method comprising:
a lens mounting step of mounting a lens in a lens holder;
an image sensor mounting step of mounting an image sensor to a top face of a substrate;
a coating step of applying an adhesive to the top face of the substrate outside the image sensor, the adhesive being configured to attach the lens holder; and
a fixing step of fixing the lens holder to the top face of the substrate via the adhesive, wherein
an inner circumferential surface of the lens holder and an outer circumferential surface of the image sensor have such a positional relationship that an offset in an in-plane direction of the substrate between a center line of the image sensor and an optical axis of the lens is smaller than or equal to a tolerable error.

7. The method according to claim 6, wherein the fixing step includes a positioning step of aligning the optical axis of the lens and the center line of the image sensor by moving a part of the inner circumferential surface of the lens holder into contact with a part of the outer circumferential surface of the image sensor mounted to the top face of the substrate.
